(19) United States
(12) Patent Application Publication
(10) Pub. No.: US 2020/0001716 A1
(43) Pub. Date: Jan. 2, 2020

(54) CONTROL APPARATUS OF SELF-DRIVING VEHICLE

(71) Applicant: Honda Motor Co., Ltd., Tokyo (JP)

(72) Inventors: Shogo Takano, Wako-shi (JP); Kota Saito, Wako-shi (JP); Chao Niu, Wako-shi (JP); Takashi Adachi, Wako-shi (JP)

(21) Appl. No.: 16/448,735

(22) Filed: Jun. 21, 2019

(30) Foreign Application Priority Data
Jun. 28, 2018 (JP) 2018-122738

(51) Int. Cl. B60K 28/16; B60L 3/10; B62D 15/02; B60W 30/18; B62D 5/04; B60W 10/20; B60W 30/045

(52) U.S. Cl. CPC B60K 28/16; B60L 3/10; B62D 15/024; B60W 2050/0005; B62D 5/0463; B60W 10/20; B60W 30/045; B60W 30/18172

(57) ABSTRACT

A control apparatus of a self-driving vehicle with a self-driving capability including a slip detector detecting a slip generated at four drive wheels, a direction detector detecting a direction of a vehicle body, and a microprocessor and a memory. The microprocessor is configured to perform: calculating target torques of the four drive wheels in accordance with an action plan; correcting the target torques so as to decrease the target torque of the first drive wheel when the slip of the first drive wheel is detected, and thereafter so as to increase the target torque of the second drive wheel and decrease the target torque of the fourth drive wheel when a deviation of the detected direction from a target traveling direction is greater than or equal to a predetermined deviation; and controlling a driving part in accordance with the corrected target torque.

### CROSS-REFERENCE TO RELATED APPLICATION

This application is based upon and claims the benefit of priority from Japanese Patent Application No. 2018-122738 filed on Jun. 28, 2018, the content of which is incorporated herein by reference.

### BACKGROUND OF THE INVENTION

### Field of the Invention

This invention relates to a control apparatus of a self-driving vehicle.

### Description of the Related Art

Conventionally, regarding an electric vehicle whose four wheels on front left and right, and rear left and right are individually driven as drive wheels by four motors, there is a known apparatus which endeavors to recover from slip condition by controlling torques of the motors when drive wheels are slipping. Such an apparatus is described in Japanese Unexamined Patent Publication No. 2015-023691 (JP2015-023691A), for example. In the apparatus described in JP2015-023691A, when any of the drive wheels slips, torque of the drive wheel which slips is decreased and torque equivalent to the decrease is added to torques of other wheels which do not slip.

A point of interest in this regard is that when vehicle body yaw angle changes after occurrence of wheel slip, vehicle traveling stability deteriorates and some countermeasure is therefore desirable. However, the apparatus described in JP2015-023691A is configured merely to determine whether any of the drive wheel slips and control torque of the motors based on the result of the determination, so that the apparatus described in JP2015-023691A cannot adequately ensure vehicle traveling stability when body yaw angle changes after wheel slip occurs.

### SUMMARY OF THE INVENTION

An aspect of the present invention is a control apparatus of a self-driving vehicle with a self-driving capability. The self-driving vehicle includes a driving part configured to individually drive four drive wheels in a front and rear direction and a left and right direction, and the four drive wheels are a first drive wheel, a second drive wheel on a same side of the first drive wheel in the left and right direction and on an opposite side of the first drive wheel in the front and rear direction, a third drive wheel on an opposite side of the first drive wheel in the left and right direction and on a same direction of the first drive wheel in the front and rear direction, and a fourth drive wheel on the opposite side of the first drive wheel in the left and right direction and on the opposite side of the first drive wheel in the front and rear direction. The apparatus includes a slip detector configured to detect a slip generated at each of the four drive wheels, a direction detector configured to detect a direction of a vehicle body of the self-driving vehicle, and an electronic control unit having a microprocessor and a memory. The microprocessor is configured to perform: generating an action plan of the self-driving vehicle; calculating a target torque of the each of the four drive wheels in accordance with the action plan; correcting the target torque so as to decrease the target torque of the first drive wheel when the slip of the first drive wheel is detected by the slip detector, and thereafter so as to increase the target torque of the second drive wheel and decrease the target torque of the fourth drive wheel when a deviation of the direction detected by the direction detector from a target traveling direction of the self-driving vehicle determined by the action plan is greater than or equal to a predetermined deviation; and controlling the driving part in accordance with the target torque corrected in the correcting.

### BRIEF DESCRIPTION OF THE DRAWINGS

The objects, features, and advantages of the present invention will become clearer from the following description of embodiments in relation to the attached drawings, in which:

FIG. 1 is a diagram showing a configuration overview of a driving system of a self-driving vehicle incorporating a control apparatus according to an embodiment of the invention;

FIG. 2 is a block diagram schematically illustrating overall configuration of a vehicle control system controlling the self-driving vehicle of FIG. 1;

FIG. 3A is a diagram showing an example of an action during slipping of the vehicle;

FIG. 3B is a diagram showing an example of an action following the action of FIG. 3A;

FIG. 4 is a block diagram illustrating main configuration of the control apparatus according to the embodiment of the invention;

FIG. 5 is a flowchart showing an example of processing performed by a controller of FIG. 4; and

FIG. 6 is a time chart showing an example of actions performed by the control apparatus according to the embodiment of the invention.

### DETAILED DESCRIPTION OF THE INVENTION

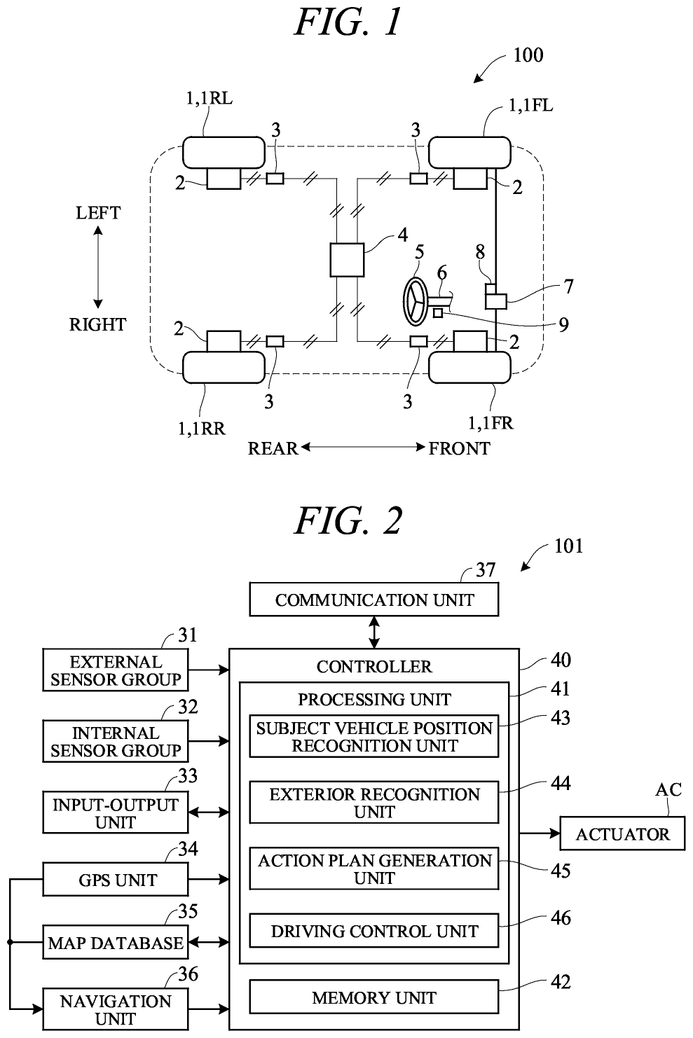

Hereinafter, an embodiment of the present invention is explained with reference to FIGS. 1 to 6. A control apparatus according to an embodiment of the invention is applied to a self-driving vehicle with a self-driving capability (also called “subject vehicle” or merely “vehicle”). First, a configuration of the self-driving vehicle is explained.

FIG. 1 is a diagram showing a configuration overview of a driving system of a vehicle 100 incorporating a control apparatus according to an embodiment of the present invention. The vehicle 100 is not limited to driving in a self-drive mode requiring no driver driving operations but is also capable of driving in a manual drive mode by driver operations. As shown in FIG. 1, the vehicle 100 is a four-wheel-drive vehicle whose four wheels 1 on front left and right, and rear left and right, namely, left and right front wheels 1FL, 1FR, and left and right rear wheels 1RL, 1RR, are all drive wheels. In the following, the four drive wheels 1FL, 1FR, 1RL and 1RR are sometimes called left front wheel, right front wheel, left rear wheel and right rear wheel, respectively.

A motor (electric motor) 2 is connected to each of the drive wheels 1. The motors 2 are connected through inverters 3 to a battery 4 and are driven by power supplied from the battery 4. On the other hand, when the motors 2 are driven by external force, they generate electricity that is stored in the battery 4. Owing to provision of the motors 2 each in association with one of the drive wheels 1 in this manner, the drive wheels 1 can be driven independently of one another. Driving of the motors 2 is controlled by the inverter 3 under control of a controller (FIG. 2).

A steering wheel 5 to be rotationally operated by a driver is installed at a driver's seat. One end portion of a steering shaft 6 is connected to the steering wheel 5 to rotate integrally with the steering wheel 5, and a steering gear box 7 of rack-and-pinion type, for example, is connected to another end portion of the steering shaft 6. The rack of the steering gear box 7 moves laterally (left and right) in response to rotation of the steering wheel 5, thereby turning the front drive wheels 1FL and 1FR leftward and rightward.

A turning actuator 8 is attached to the steering gear box 7. The turning actuator 8 is configured as an electric motor, for example. The turning actuator 8 can drive the rack of the steering gear box 7 left and right. This facilitates steering of the front drive wheels 1FL and 1FR without the driver operating the steering wheel. A steering actuator 9 is attached to the steering shaft 6. The steering actuator 9 is configured as an electric motor, for example. The steering actuator 9 drives the steering shaft 6 to apply reaction force in response to driver steering wheel manipulation. Reaction force applied by the steering actuator 9 in response to driver steering wheel manipulation is greater in proportion as amount of manipulation of the steering wheel 5 is greater.

FIG. 2 is a block diagram schematically illustrating overall configuration of a vehicle control system 101 according to the present embodiment, and shows a configuration in relation to self-driving. As shown in FIG. 2, the vehicle control system 101 includes mainly the controller 40, and as members communicably connected with the controller 40 through CAN (Controller Area Network) communication or the like, an external sensor group 31, an internal sensor group 32, an input-output unit 33, a GPS unit 34, a map database 35, a navigation unit 36, a communication unit 37, and actuators AC for traveling.

The term external sensor group 31 herein is a collective designation encompassing multiple sensors (external sensors) for detecting external circumstances constituting vehicle ambience data. For example, the external sensor group 31 includes, inter alia, a LIDAR (Light Detection and Ranging) for measuring distance from the vehicle 100 to ambient obstacles by measuring scattered light produced by laser light radiated from the vehicle 100 in every direction, a RADAR (Radio Detection and Ranging) for detecting other vehicles and obstacles around the vehicle 100 by radiating electromagnetic waves and detecting reflected waves, and cameras having a CCD, CMOS or other image sensor and attached to the vehicle 100 for imaging ambience (forward, reward and sideways) of the vehicle 100.

The term internal sensor group 32 herein is a collective designation encompassing multiple sensors (internal sensors) for detecting driving state of the vehicle 100. For example, the internal sensor group 32 includes, inter alia, a vehicle speed sensor for detecting vehicle speed of the vehicle 100 and acceleration sensors for detecting forward-rearward direction acceleration and lateral acceleration of the vehicle 100, respectively, and a throttle opening angle sensor for detecting an opening angle of the throttle valve (throttle opening angle). The internal sensor group 32 also includes sensors for detecting driver driving operations in manual drive mode, including, for example, accelerator pedal operations, brake pedal operations, steering wheel 5 operations and the like.

The term input-output unit 33 is used herein as a collective designation encompassing apparatuses receiving instructions input by the driver and outputting information to the driver. The input-output unit 33 includes, inter alia, switches which the driver uses to input various instructions, a microphone which the driver uses to input voice instructions, a display for presenting information to the driver via displayed images, and a speaker for presenting information to the driver by voice. The switch of the input-output unit 33 includes a self/manual drive select switch for instructing a self-drive mode or manual drive mode.

The self/manual drive select switch, for example, is configured as a switch manually operable by the driver to output an instruction of switching to a self-drive mode enabling self-drive functions or a manual drive mode disabling self-drive functions in accordance with operation of the switch. Optionally, the self/manual drive select switch can be configured to instruct switching from manual drive mode to self-drive mode or from self-drive mode to manual drive mode without operating the self/manual drive select switch. For example, when a predetermined operation is made by a driver or a predetermined condition is satisfied, drive mode can be switched automatically to self-drive mode or manual drive mode.

The GPS unit 34 includes a GPS receiver (GPS sensor) for receiving position determination signals from multiple GPS satellites, and measures absolute position (latitude, longitude and the like) of the vehicle 100 based on the signals received from the GPS receiver.

The map database 35 is a unit storing general map data used by the navigation unit 36 and is, for example, implemented using a hard disk. The map data include road position data and road shape (curvature etc.) data, along with intersection and road branch position data. The map data stored in the map database 35 are different from high-accuracy map data stored in a memory unit 42 of the controller 40.

The navigation unit 36 retrieves target road routes to destinations input by the driver and performs guidance along selected target routes. Destination input and target route guidance is performed through the input-output unit 33. Destination can be automatically set not through the input-output unit 33. Target routes are computed based on current position of the vehicle 100 measured by the GPS unit 34 and map data stored in the map database 35.

The communication unit 37 communicates through networks including the Internet and other wireless communication networks to access servers (not shown in the drawings) to acquire map data, traffic data and the like, periodically or at arbitrary times. Acquired map data are output to the map database 35 and/or memory unit 42 to update their stored map data. Acquired traffic data include congestion data and traffic light data including, for instance, time to change from red light to green light.

The actuators AC are actuators for operating various devices in relation to vehicle traveling, i.e., for traveling of the vehicle 100. The actuators AC include four motors 2 for driving the four drive wheels 1, respectively, a brake actuator for operating a braking device, and the turning actuator 8 for turning the front wheels 1FL and 1FR. Although the motors 2 are controlled by the inverters 3, as shown in FIG. 1, illustrations of the inverters 3 are omitted in FIG. 2.

The controller 40 is constituted by an electronic control unit (ECU). In FIG. 2, the controller 40 is integrally configured by consolidating multiple function-differentiated ECUs such as a motor control ECU, a turning control ECU and so on. Optionally, these ECUs can be individually provided. The controller 40 incorporates a computer including a CPU or other processing unit (a microprocessor) 41 for executing a processing in relation to travel control, the memory unit (a memory) 42 of RAM, ROM, hard disk and the like, and an input-output interface or other peripheral circuits not shown in the drawings.

The memory unit 42 stores high-accuracy detailed map data including, inter alia, lane center position data and lane boundary line data. More specifically, road data, traffic regulation data, address data, facility data, telephone number data and the like are stored as map data. The road data include data identifying roads by type such as expressway, toll road and national highway, and data on, inter alia, number of road lanes, individual lane width, road gradient, road 3D coordinate position, lane curvature, lane merge and branch point positions, and road signs. The traffic regulation data include, inter alia, data on lanes subject to traffic restriction or closure owing to construction work and the like. The memory unit 42 also stores various programs for performing processing, and threshold values used in the programs, etc.

As functional configurations in relation to mainly self-driving, the processing unit 41 includes a subject vehicle position recognition unit 43, an exterior recognition unit 44, an action plan generation unit 45, and a driving control unit 46.

The subject vehicle position recognition unit 43 recognizes map position of the vehicle 100 (subject vehicle position) based on subject vehicle position data calculated by the GPS unit 34 and map data stored in the map database 35. Optionally, the subject vehicle position can be recognized using map data (building shape data and the like) stored in the memory unit 42 and ambience data of the vehicle 100 detected by the external sensor group 31, whereby the subject vehicle position can be recognized with high accuracy. Optionally, when the subject vehicle position can be measured by sensors installed externally on the road or by the roadside, the subject vehicle position can be recognized with high accuracy by communicating with such sensors through the communication unit 37.

The exterior recognition unit 44 recognizes external circumstances around the vehicle 100 based on signals from cameras, LIDERs, RADARS and the like of the external sensor group 31. For example, it recognizes position, speed and acceleration of nearby vehicles (forward vehicle or rearward vehicle) driving in the vicinity of the vehicle 100, position of vehicles stopped or parked in the vicinity of the vehicle 100, and position and state of other objects. Other objects include traffic signs, traffic lights, road boundary and stop lines, buildings, guardrails, power poles, commercial signs, pedestrians, bicycles, and the like. Recognized states of other objects include, for example, traffic light color (red, green or yellow) and moving speed and direction of pedestrians and bicycles.

The action plan generation unit 45 generates a driving path (target path) of the vehicle 100 from present time point to a certain time ahead based on, for example, a target route computed by the navigation unit 36, subject vehicle position recognized by the subject vehicle position recognition unit 43, and external circumstances recognized by the exterior recognition unit 44. When multiple paths are available on the target route as target path candidates, the action plan generation unit 45 selects from among them the path that optimally satisfies legal compliance, safe efficient driving and other criteria, and defines the selected path as the target path. The action plan generation unit 45 then generates an action plan matched to the generated target path. An action plan is also called “travel plan”.

The action plan includes action plan data set for every unit time Δt (e.g., 0.1 sec) between present time point and a predetermined time period T (e.g., 5 sec) ahead, i.e., includes action plan data set in association with every unit time Δt interval. The action plan data include position data of the vehicle 100 and vehicle state data for every unit time Δt. The position data are, for example, target point data indicating 2D coordinate position on road, and the vehicle state data are vehicle speed data indicating vehicle speed, direction data indicating direction of the vehicle 100, and the like. Action plan is updated every unit time Δt.

The action plan generation unit 45 generates the target path by connecting position data at every unit time Δt between present time point and predetermined time period T ahead in time order. Further, the action plan generation unit 45 calculates acceleration (target acceleration) of sequential unit times Δt, based on vehicle speed (target vehicle speed) corresponding to target point data of sequential unit times Δt on target path. In other words, the action plan generation unit 45 calculates target vehicle speed and target acceleration. Optionally, the driving control unit 46 can calculate target acceleration.

The driving control unit 46 controls the actuators AC in accordance with drive mode (self-drive mode, manual drive mode). For example, in self-drive mode, the driving control unit 46 controls the actuators AC to drive the vehicle 100 along a target path generated by the action plan generation unit 45. More specifically, in self-drive mode, the driving control unit 46 calculates required driving force for achieving the target accelerations at each unit time included in the action plan generated by the action plan generation unit 45, taking running resistance caused by road gradient and the like into account. And the actuators AC are feedback controlled to bring actual acceleration detected by the internal sensor group 32, for example, into coincidence with target acceleration. In other words, it controls the actuators AC so that the vehicle 100 travels at target vehicle speed and target acceleration. On the other hand, in manual drive mode, the driving control unit 46 controls the actuators AC in accordance with driving instructions by the driver (accelerator opening angle and the like) acquired from the internal sensor group 32.

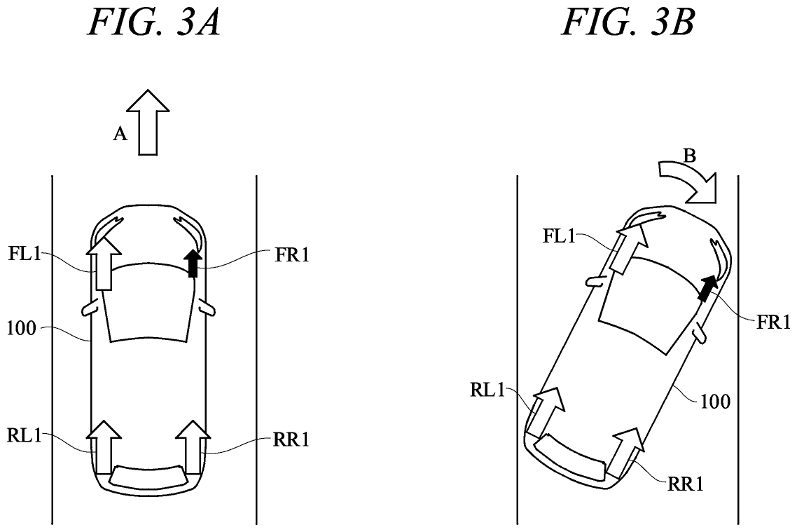

An issue to be considered here is that when one of the drive wheels 1 slips (spins) in self-driving mode during hill climbing on a sloped surface whose friction coefficient is low and uneven as in the case of a snow-covered or icy road, direction (posture) of the vehicle body is apt diverge. FIGS. 3A and 3B show an example of this. Arrows FL1, FR1, RL1 and RR1 in the drawings respectively indicate drive torque magnitudes of the motors 2 of the left front wheel 1FL, right front wheel 1FR, left rear wheel 1RL and right rear wheel 1RR. If, for example, the right front wheel 1FR of the vehicle 100 slips when the vehicle is driving straight ahead in direction of arrow A (forward) as shown in FIG. 3A, the vehicle 100 is apt to veer (diverge) rightward as indicated by arrow B in FIG. 3B. In order to enable prompt recovery from such path divergence and restore traveling of the vehicle 100 to direction of advance on target path (arrow A), a control apparatus of a self-driving vehicle according to the present embodiment is configured as set forth in the following.

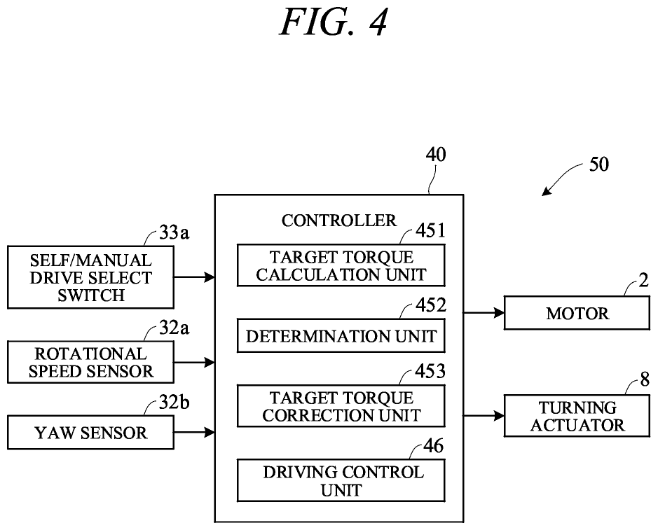

FIG. 4 is a block diagram showing main components of a control apparatus 50 according to an embodiment of the present embodiment. This control apparatus 50 is adapted to control traveling actions of the vehicle 100 and forms part of the vehicle control system 101 of FIG. 2

As shown in FIG. 4, the control apparatus 50 includes the controller 40, and connected to the controller 40, a self/manual drive select switch 33a, four rotational speed sensors 32a (only one shown), a yaw sensor 32b, the four motors 2 (only one shown), and the turning actuator 8. Although the motors 2 are controlled by the inverter 3, illustration of the inverter 3 is omitted in FIG. 4.

The self/manual drive select switch 33a forms part of the input-output unit 33 of FIG. 2. The rotational speed sensors 32a are detectors provided in association with the drive wheels 1FL, 1FR, 1RL and 1RR for detecting rotational speeds of the drive wheels 1FL, 1FR, 1RL and 1RR, and form part of the internal sensor group 32 of FIG. 2. The yaw sensor 32b is a detector for detecting rotation angle (yaw angle from a reference line) of the vehicle 100 (body thereof) around its center of gravity vertical axis, i.e., orientation of the vehicle 100, and is configured using a camera, for example. The reference line coincides with target traveling direction of the vehicle 100, and a yaw angle of 0° means the vehicle 100 is advancing in the target traveling direction. Optionally, yaw angle can be calculated using a signal from an angular velocity sensor that detects angular velocity (yaw rate) of the vehicle 100 (body thereof) around its center of gravity vertical axis.

As main functional configurations, the controller 40 includes a target torque calculation unit 451, a determination unit 452, a target torque correction unit 453, and the driving control unit 46. The target torque calculation unit 451, determination unit 452 and target torque correction unit 453 are, for example, configured to form part of the action plan generation unit 45 of FIG. 2.

The target torque calculation unit 451 calculates target torques of the drive wheels 1FL, 1FR, 1RL and 1RR for obtaining required driving force calculated by the action plan generation unit 45. The reason for the target torque calculation unit 451 calculating target torques in accordance with required driving force is that required driving force is obtained as sum total of target torques of the individual drive wheels 1FL, 1FR, 1RL and 1RR. In this calculation, when the action plan generation unit 45 generates a target path following a straight line, target torques of the drive wheels 1FL, 1FR, 1RL and 1RR are typically all equal. However, setting of target torques is not limited to this example, and it is possible instead, for example, to set target torques of the front drive wheels 1FL and 1FR a predetermined percent greater than target torques of the rear drive wheels 1RL and 1RR. When a target path generated by the action plan generation unit 45 follows not a straight line but a curve, the target torque calculation unit 451 calculates target torques so that difference arises between torque of left and right drive wheels 1 (e.g., between left front wheel 1FL and right front wheel 1FR).

The determination unit 452 determines whether direction of the vehicle 100 needs to be controlled (whether vehicle posture correction control is necessary). Specifically, whether any drive wheel 1 is slipping is first determined based on signals from the rotational speed sensors 32a. This determination is made based on the fact that when a drive wheel 1 slips, spinning of that wheel 1 causes its rotational speed to suddenly rise to higher than the other drive wheels 1. Therefore, when presence of a drive wheel 1 whose rotational speed suddenly increased is discovered, e.g., when rotational speed difference between a certain drive wheel 1 and other drive wheels 1 is greater than a predetermined value, the determination unit 452 determines that that drive wheel 1 is in slip condition.

After detecting slip condition, the determination unit 452 further determines whether change of vehicle body yaw angle (yaw deviation Δα) of predetermined value Δα1 or greater has been detected by the yaw sensor 32b. This amounts to determining whether direction of the vehicle 100 relative to target traveling direction changed by a predetermined angle (e.g., about 5°) or greater per unit time, and predetermined value Δα1 is suitably defined to make this determination possible. When yaw deviation Δα of predetermined value Δα1 or greater is detected by the yaw sensor 32b, the determination unit 452 determines that vehicle posture correction control is necessary.

When the determination unit 452 determines that a drive wheel 1 is slipping, the target torque correction unit 453 decreases target torque of that drive wheel 1 (called “slipping wheel”). For example, it sets target torque of the slipping wheel to 0. Further, when the determination unit 452 determines from yaw deviation Δα of predetermined value Δα1 being detected that vehicle posture correction control is necessary, the target torque correction unit 453 decreases target torque of the drive wheel 1 located diagonally opposite the slipping wheel, i.e., of the wheel 1 on opposite right-left side and opposite front-rear end from the slipping wheel, e.g., decreases its target torque to 0. In addition, it increases target torque of the drive wheel 1 on same left-right side as and opposite front-rear end from the slipping wheel. In this case, target torque is, for example, increased to greater degree as yaw deviation Δα is greater.

When the determination unit 452 determines that vehicle posture correction control is unnecessary, the driving control unit 46 controls driving torques of the motors 2 in accordance with target torques of the drive wheels 1 so that the drive wheels 1 output target torques calculated by the target torque calculation unit 451. When the determination unit 452 determines that vehicle posture correction control is necessary, the driving control unit 46 controls driving torques of the motors 2 in accordance with target torques of the drive wheels 1 so that the drive wheels 1 output target torques corrected by the target torque correction unit 453. At this time, the driving control unit 46 additionally outputs a control signal to the turning actuator 8 to turn the front drive wheels 1 in opposite direction from direction in which yaw deviation Δα occurred (leftward in the example of FIG. 3B). In this case, turning angle is, for example, increased more as yaw deviation Δα is greater.

When the determination unit 452 determines that vehicle posture correction control is necessary, the driving control unit 46 first outputs a control signal to the turning actuator 8 to turn the front drive wheels 1 in opposite direction from direction in which yaw deviation Δα occurred and thereafter controls driving torques of the motors 2 in accordance with target torques corrected by the target torque correction unit 453. Optionally at this time, driving torques can be adjusted in accordance with turning angle so as to enable traveling of the vehicle 100 at target vehicle speed. For example, this can be achieved by calculating cornering resistance in accordance with turning angle and adjusting driving torques of the motors 2 in accordance with calculated cornering resistance.

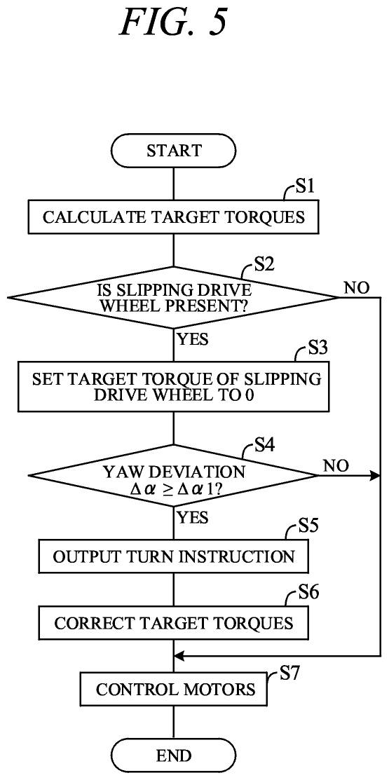

FIG. 5 is a flowchart showing an example of processing performed by the CPU of the controller 40 of FIG. 4 in accordance with a program stored in the memory unit 42 in advance. The processing shown in this flowchart is, for example, started when self-drive mode is instructed by the self/manual drive select switch 33a and periodically repeated.

First, in S1 (S: processing Step), target torques of the drive wheels 1FL, 1FR, 1RL and 1RR are calculated. Next, in S2, whether a slipping drive wheel 1 is present is determined based on signals from the rotational speed sensors 32a. If a positive decision is made in S2, the routine proceeds to S3, and if a negative decision is made, the routine skips S3 to S6 and proceeds to S7. In S3, target torque of the drive wheel 1 determined in S2 to be in slip condition (slipping wheel) is set to 0.

Next, in S4, whether yaw deviation Δα is equal to or greater than predetermined value Δα1 is determined based on a signal from the yaw sensor 32b. If a positive decision is made in S4, the routine proceeds to S5, and if a negative decision is made, the routine skips S5 and S6 and proceeds to S7. In S5, a signal (turn instruction) is output to the turning actuator 8 to turn the front drive wheels 1 in opposite direction from direction in which yaw deviation Δα occurred.

Next, in S6, target torques of the wheel 1 located diagonally opposite the slipping wheel and of the drive wheel 1 on same left-right side as and opposite front-rear end from the slipping wheel are corrected. Specifically, target torque of the wheel 1 located diagonally opposite the slipping wheel is set to 0 and target torque of the drive wheel 1 on same left-right side as and opposite front-rear end from the slipping wheel is increased. Next, in S7, control signals are output to the inverters 3 to control driving torques of the motors 2. In other words, driving torques of the motors 2 are controlled to corrected target torques when target torques are corrected in S6 and controlled to target torques calculated in S1 when not corrected.

Correction of target torque in S6 is continued until yaw deviation Δα becomes equal to or less than a predetermined value (e.g., 0). In other words, although not indicated in the drawing, once a positive decision is made in S4, whether yaw deviation Δα has become equal to or less than the predetermined value is determined in a repetitious routine instead of by the processing of S4, and the turning instruction processing of S5 and the target torque correction processing of S6 are performed until yaw deviation Δα becomes equal to or less than the predetermined value (e.g., until yaw deviation Δα becomes 0).

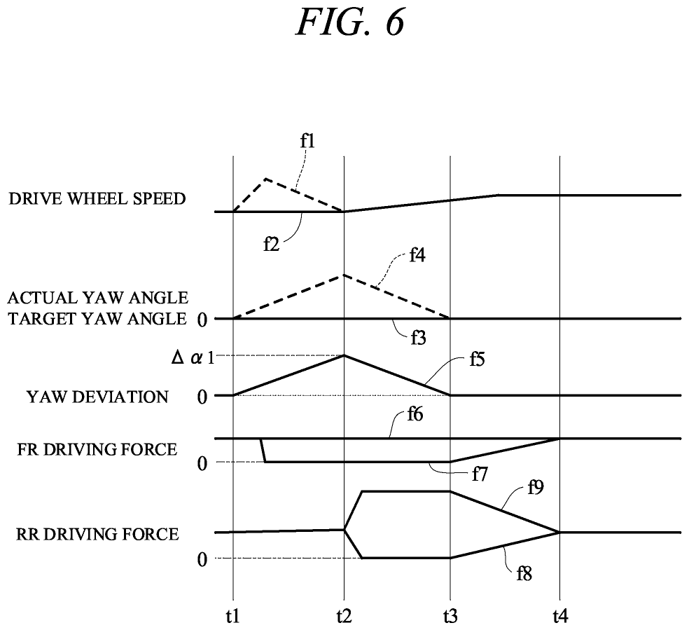

FIG. 6 is a time chart showing an example of actions performed by the control apparatus 50 according to the present embodiment. The example of FIG. 6 shows time-course changes in drive wheel speed, yaw angle, yaw deviation, and driving force of each of the drive wheels 1 when the vehicle 100 is traveling straight ahead uphill. In particular, characteristic curves f1 and f2 in FIG. 6 respectively represent characteristics of drive wheel speed of a slipping drive wheel 1 (e.g., right front wheel 1FR) and characteristics of a non-slipping drive wheel 1 (e.g., left front wheel 1FL, left rear wheel 1RL and right rear wheel 1RR). Characteristic curves f3 and f4 respectively represent characteristics of target yaw angle calculable from an action plan and characteristics of actual yaw angle detected by the yaw sensor 32b. Characteristic curve f5 represents characteristics of difference between target yaw angle and actual yaw angle, i.e., characteristics of yaw deviation Δα. Characteristic curves f6 and f7 respectively represent driving force characteristics of left front wheel 1FL and right front wheel 1FR, and characteristic curves f8 and f9 respectively represent driving force characteristics of left rear wheel 1RL and right rear wheel 1RR.

During straight traveling, target yaw angle is 0°. As shown in FIG. 6, when the right front wheel 1FR slips at time t1 (characteristic curve f1), driving force of the right front wheel 1FR becomes 0 as indicated by characteristic curve f7 (S3). Slipping of the right front wheel 1FR increases actual yaw angle (characteristic curve f4), and when yaw deviation Δα becomes equal to or greater than predetermined value Δα1 at time t2 as indicated by characteristic curve f5, driving force of the left rear wheel 1RL becomes 0 as indicated by characteristic curve f8 and driving force of the right rear wheel 1RR increases as indicated by characteristic curve f9 (S6). Although not indicated in the drawing, the front drive wheels 1FL and 1FR are turned leftward at this time (S5).

As a result, yaw deviation Δα decreases and vehicle posture is corrected so as to orient the vehicle 100 to target traveling direction. When yaw deviation Δα becomes 0 at time t3, driving force of the right front wheel 1FR increases as indicated by characteristic curve f7, driving force of the left rear wheel 1RL increases as indicated by characteristic curve f8, and driving force of the right rear wheel 1RR decreases as indicated by characteristic curve f9. At time t4, the drive wheels 1FL, 1FR, 1RL and 1RR are restored to their original driving force and difference between left and right driving force is eliminated. Optionally, difference between left and right driving force can be gradually reduced with diminishing yaw deviation Δα up to the point that yaw deviation Δα reaches 0. For example, difference between left and right driving force can be controlled to converge on 0 at the same time as yaw deviation Δα reaches 0.

The present embodiment can achieve advantages and effects such as the following:

(1) The vehicle 100 has self-driving capability and includes the motors 2 for individually driving the four drive wheels 1FL, 1FR, 1RL and 1RR on front left and right, and rear left and right. The control apparatus 50 of this self-driving vehicle includes: the target torque calculation unit 451 for calculating target torques of the four drive wheels 1FL, 1FR, 1RL and 1RR in accordance with an action plan; the rotational speed sensors 32a for detecting slip condition of the four drive wheels 1FL, 1FR, 1RL and 1RR; the yaw sensor 32b for detecting change of yaw angle of the vehicle body; the target torque correction unit 453 for correcting target torques calculated by the target torque calculation unit 451 by, in response to detection by the rotational speed sensors 32a of slip condition of, for example, the right front wheel 1FR, decreasing target torque of the slipping wheel 1FR, and in response to detection by the yaw sensor 32b thereafter of change of vehicle body yaw angle (yaw deviation Δα) of or greater than predetermined value Δα1, increasing target torque of right rear wheel 1RR located on same left-right side as and opposite front-rear end from the slipping wheel 1FR and decreasing target torque of the left rear wheel 1RL located on opposite right-left side and opposite front-rear end from the slipping wheel 1FR; and the driving control unit 46 for controlling the motors 2 in accordance with target torques corrected by the target torque correction unit 453 (FIG. 4).

Therefore, after yaw deviation changes to predetermined value Δα1 or greater from a target traveling direction determined by the action plan generated in the action plan generation unit 45, owing to slipping of the right front wheel 1FR, driving torques of other drive wheels 1RL and 1RR are corrected. This makes differences between left and right driving torques of the front drive wheels 1FL and 1FR and between left and right driving torques of the rear drive wheels 1RL and 1RR, during straight traveling. As a result, posture (direction) of the vehicle 100 can be readily restored to original orientation and traveling stability of the vehicle 100 whose body yaw angle has changed after slipping can be thoroughly ensured. Moreover, a case may arise in which posture of the vehicle 100 does not change even though a drive wheel 1 has experienced slipping, but since driving torque is not corrected in such a case because yaw deviation Δα stays less than predetermined value Δα1, no correction of driving torque is performed and behavior of the vehicle 100 can be maintained stable.

(2) The vehicle 100 further includes the turning actuator 8 for turning the drive wheels 1FL and 1FR (FIG. 4). When yaw deviation Δα of predetermined value Δα1 or greater is detected by the yaw sensor 32b after slipping state of the right front wheel 1FR, for example, is detected by the rotational speed sensors 32a, the driving control unit 46 additionally controls the turning actuator 8 in accordance with change of yaw angle of the vehicle body detected by the yaw sensor 32b. Owing to this accompanying performance of turning, the vehicle 100 can be promptly restored to original posture when yaw angle of the vehicle 100 changes to predetermined value Δα1 or greater.

(3) When slip condition of the right front wheel 1FR, for example, is detected by the rotational speed sensors 32a, the target torque correction unit 453 decreases target torque of the right front wheel 1FR to 0, and when yaw deviation Δα of predetermined value Δα1 or greater is thereafter detected by the yaw sensor 32b, the target torque correction unit 453 increases target torque of the right rear wheel 1RR and decreases target torque of the left rear wheel 1RL to 0. Therefore, since correction of driving torques of non-slipping drive wheels (e.g., 1RL and 1RR) is appropriately performed in accordance with location of the slipping wheel (e.g., 1FR), the vehicle 100 can be oriented in target traveling direction.

Various modifications of the present embodiment are possible. Some examples are explained in the following. Although in the above embodiment, an example of slipping of the right front wheel 1FR as a first drive wheel is explained, a drive wheel other than the right front wheel 1FR may be the first drive wheel. Therefore, a second drive wheel (the same side of the first drive wheel in left and right direction and the opposite side of the first drive wheel in front and rear direction) for increasing target torque when it is determined that vehicle posture correction control is necessary may be a drive wheel other than the right rear wheel 1RR, and a fourth drive wheel (the opposite side of the first drive wheel in left and right direction and the opposite side of the first drive wheel in front and rear direction) for decreasing target torque may be a drive wheel other than the left rear wheel 1RL. Furthermore, a third drive wheel (the opposite side of the first drive wheel in left and right direction and the same side of the first drive wheel in front and rear direction) may be a drive wheel other than the left front wheel 1FL.

In the above embodiment, when slipping of the first drive wheel is detected, target torque thereof is set to 0. However, as long as target torque of the first drive wheel is decreased at the time of slipping of the first drive wheel, target torque of the first drive wheel may be greater than 0 or smaller than 0. In the above embodiment, when it is determined that vehicle posture correction control is necessary, target torque of the fourth drive wheel is set to 0. However, as long as target torque of the fourth drive wheel is decreased, target torque of the fourth drive wheel may be greater than 0 or smaller than 0. In other words, a target torque correction unit for correcting target torque calculated by a target torque calculation unit is not limited to the above configuration. When target torque is corrected, for example, target torque of the fourth drive wheel is decreased, the driving control unit 46 can operate the braking device in accordance with corrected target torque.

Although in the above embodiment, slip condition of the vehicle 100 is detected by rotational speed sensor 32a, a slip detector is not limited to the above configuration. Although in the above embodiment, yaw angle of the vehicle 100 is detected by the yaw sensor 32b, a direction detector other than yaw sensor 32b may be used for detecting a direction of the vehicle. For example, yaw rate sensor can be also used as the direction detector. In the above embodiment, front side left and rear drive wheel 1FL and 1FR are turned by the turning actuator 8. However, as long as at least two of four drive wheel 1FL, 1FR, 1RL and 1RR are turned, a turning part is not limited to the above configuration. In the above embodiment (FIG. 5), when it is determined that vehicle posture correction control is necessary, target torque is corrected after turning of the drive wheel 1FL and 1FR. However, the turning may be performed after correcting of target torque, or correcting of target torque may be only performed without performing turning.

Although in the above embodiment, the four motors 2 connected to the four drive wheels 1 are used as a driving part, the driving part is not limited to the above configuration. In-wheels motors housed in drive wheels may be used as the driving part. Although in the above embodiment, an example of a case that the vehicle travels uphill is explained, the present invention can be also applied to a case that the vehicle travels on level ground.

The present invention can also be used as a control method of a self-driving vehicle with a self-driving capability.

The above embodiment can be combined as desired with one or more of the above modifications. The modifications can also be combined with one another.

According to the present invention, traveling stability of the vehicle whose body yaw angle has changed after slipping can be thoroughly ensured.

Above, while the present invention has been described with reference to the preferred embodiments thereof, it will be understood, by those skilled in the art, that various changes and modifications may be made thereto without departing from the scope of the appended claims.

What is claimed is:

1. A control apparatus of a self-driving vehicle with a self-driving capability, the self-driving vehicle including a driving part configured to individually drive four drive wheels in a front and rear direction and a left and right direction, the four drive wheels being a first drive wheel, a second drive wheel on a same side of the first drive wheel in the left and right direction and on an opposite side of the first drive wheel in the front and rear direction, a third drive wheel on an opposite side of the first drive wheel in the left and right direction and on a same direction of the first drive wheel in the front and rear direction, and a fourth drive wheel on the opposite side of the first drive wheel in the left and right direction and on the opposite side of the first drive wheel in the front and rear direction,
the apparatus comprising:
a slip detector configured to detect a slip generated at each of the four drive wheels;
a direction detector configured to detect a direction of a vehicle body of the self-driving vehicle; and
an electronic control unit having a microprocessor and a memory, wherein
the microprocessor is configured to perform:
generating an action plan of the self-driving vehicle;
calculating a target torque of the each of the four drive wheels in accordance with the action plan;
correcting the target torque so as to decrease the target torque of the first drive wheel when the slip of the first drive wheel is detected by the slip detector, and thereafter so as to increase the target torque of the second drive wheel and decrease the target torque of the fourth drive wheel when a deviation of the direction detected by the direction detector from a target traveling direction of the self-driving vehicle determined by the action plan is greater than or equal to a predetermined deviation; and
controlling the driving part in accordance with the target torque corrected in the correcting.

2. The apparatus according to claim 1, wherein
the self-driving vehicle further includes a turning part configured to turn at least two of the four drive wheels, and
the microprocessor is configured to perform
the controlling including controlling the turning part in accordance with the direction of the vehicle body detected by the direction detector when the deviation of the direction detected by the direction detector from the target traveling direction is greater than or equal to the predetermined deviation after the slip of the first drive wheel is detected by the slip detector.

3. The apparatus according to claim 2, wherein
the microprocessor is configured to perform
the controlling including controlling the turning part so as to increase a turning angle along with an increase of the deviation of the direction detected by the direction detector from the target traveling direction.

4. The apparatus according to claim 1, wherein
the microprocessor is configured to perform
the correcting including correcting the target torque calculated in the calculating so as to decrease the target torque of the first drive wheel to 0 when the slip of the first drive wheel is detected by the slip detector, and thereafter so as to increase the target torque of the second drive wheel and decrease the target torque of the fourth drive wheel to 0 when the deviation of the direction detected by the direction detector from the target traveling direction is greater than or equal to the predetermined deviation.

5. The apparatus according to claim 1, wherein
the microprocessor is configured to perform
the correcting including correcting the target torque calculated in the calculating so as to increase the target torque of the second drive wheel along with an increase of the deviation of the direction detected by the direction detector from the target traveling direction.

6. The apparatus according to claim 1, wherein
the microprocessor is configured to perform
the correcting including correcting the target torque calculated in the calculating so as to decrease the target torque of the first drive wheel when the slip of the first drive wheel is detected by the slip detector, and thereafter so as to increase the target torque of the second drive wheel and decrease the target torque of the fourth drive wheel until the deviation becomes 0 when the deviation of the direction detected by the direction detector from the target traveling direction is greater than or equal to the predetermined deviation.

7. A control apparatus of a self-driving vehicle with a self-driving capability, the self-driving vehicle including a driving part configured to individually drive four drive wheels in a front and rear direction and a left and right direction, the four drive wheels being a first drive wheel, a second drive wheel on a same side of the first drive wheel in the left and right direction and on an opposite side of the first drive wheel in the front and rear direction, a third drive wheel on an opposite side of the first drive wheel in the left and right direction and on a same direction of the first drive wheel in the front and rear direction, and a fourth drive wheel on the opposite side of the first drive wheel in the left and right direction and on the opposite side of the first drive wheel in the front and rear direction,
the apparatus comprising:
a slip detector configured to detect a slip generated at each of the four drive wheels;
a direction detector configured to detect a direction of a vehicle body of the self-driving vehicle; and
an electronic control unit having a microprocessor and a memory, wherein
the microprocessor is configured to function as:
an action plan generation unit configured to generate an action plan of the self-driving vehicle;
a target torque calculation unit configured to calculate a target torque of the each of the four drive wheels in accordance with the action plan generated by the action plan generation unit;
a target torque correction unit configured to correct the target torque calculated by the target torque calculation unit so as to decrease the target torque of the first drive wheel when the slip of the first drive wheel is detected by the slip detector, and thereafter so as to increase the target torque of the second drive wheel and decrease the target torque of the fourth drive wheel when a deviation of the direction detected by the direction detector from a target traveling direction of the self-driving vehicle determined by the action plan is greater than or equal to a predetermined deviation; and
a driving control unit configured to control the driving part in accordance with the target torque corrected by the target torque correction unit.

8. The apparatus according to claim 7, wherein
the self-driving vehicle further includes a turning part configured to turn at least two of the four drive wheels, and
the driving control unit is configured to further control the turning part in accordance with the direction of the vehicle body detected by the direction detector when the deviation of the direction detected by the direction detector from the target traveling direction is greater than or equal to the predetermined deviation after the slip of the first drive wheel is detected by the slip detector.

9. The apparatus according to claim 8, wherein
the driving control unit is configured to control the turning part so as to increase a turning angle along with an increase of the deviation of the direction detected by the direction detector from the target traveling direction.

10. The apparatus according to claim 7, wherein
the target torque correction unit is configured to correct the target torque calculated by the target torque calculation unit so as to decrease the target torque of the first drive wheel to 0 when the slip of the first drive wheel is detected by the slip detector, and thereafter so as to increase the target torque of the second drive wheel and decrease the target torque of the fourth drive wheel to 0 when the deviation of the direction detected by the direction detector from the target traveling direction is greater than or equal to the predetermined deviation.

11. The apparatus according to claim 7, wherein
the target torque correction unit is configured to correct the target torque calculated by the target torque calculation unit so as to increase the target torque of the second drive wheel along with an increase of the deviation of the direction detected by the direction detector from the target traveling direction.

12. The apparatus according to claim 7, wherein
the target torque correction unit is configured to correct the target torque calculated by the target torque calculation unit so as to decrease the target torque of the first drive wheel when the slip of the first drive wheel is detected by the slip detector, and thereafter so as to increase the target torque of the second drive wheel and decrease the target torque of the fourth drive wheel until the deviation becomes 0 when the deviation of the direction detected by the direction detector from the target traveling direction is greater than or equal to the predetermined deviation.

13. A control method of a self-driving vehicle with a self-driving capability, the self-driving vehicle including a driving part configured to individually drive four drive wheels in a front and rear direction and a left and right direction, the four drive wheels being a first drive wheel, a second drive wheel on a same side of the first drive wheel in the left and right direction and on an opposite side of the first drive wheel in the front and rear direction, a third drive wheel on an opposite side of the first drive wheel in the left and right direction and on a same direction of the first drive wheel in the front and rear direction, and a fourth drive wheel on the opposite side of the first drive wheel in the left and right direction and on the opposite side of the first drive wheel in the front and rear direction,
the method comprising:
detecting a slip generated at each of the four drive wheels;
detecting a direction of a vehicle body of the self-driving vehicle;
generating an action plan of the self-driving vehicle;
calculating a target torque of the each of the four drive wheels in accordance with the action plan;
correcting the target torque calculated in the calculating so as to decrease the target torque of the first drive wheel when the slip of the first drive wheel is detected, and thereafter so as to increase the target torque of the second drive wheel and decrease the target torque of the fourth drive wheel when a deviation of the direction detected in the detecting from a target traveling direction of the self-driving vehicle determined by the action plan is greater than or equal to a predetermined deviation; and
controlling the driving part in accordance with the target torque corrected in the correcting.

14. The method according to claim 13, wherein
the self-driving vehicle further includes a turning part configured to turn at least two of the four drive wheels, and
the controlling includes further controlling the turning part in accordance with the direction of the vehicle body detected in the detecting when the deviation of the direction detected in the detecting from the target traveling direction is greater than or equal to the predetermined deviation after the slip of the first drive wheel is detected.

15. The method according to claim 14, wherein
the controlling includes controlling the turning part so as to increase a turning angle along with an increase of the deviation of the direction detected in the detecting from the target traveling direction.

16. The method according to claim 13, wherein
the correcting includes correcting the target torque calculated in the calculating so as to decrease the target torque of the first drive wheel to 0 when the slip of the first drive wheel is detected, and thereafter so as to increase the target torque of the second drive wheel and decrease the target torque of the fourth drive wheel to 0 when the deviation of the direction detected in the detecting from the target traveling direction is greater than or equal to the predetermined deviation.

17. The method according to claim 13, wherein
the correcting includes correcting the target torque calculated in the calculating so as to increase the target torque of the second drive wheel along with an increase of the deviation of the direction detected in the detecting from the target traveling direction.

18. The method according to claim 13, wherein
the correcting includes correcting the target torque calculated in the calculating so as to decrease the target torque of the first drive wheel when the slip of the first drive wheel is detected, and thereafter so as to increase the target torque of the second drive wheel and decrease the target torque of the fourth drive wheel until the deviation becomes 0 when the deviation of the direction detected in the detecting from the target traveling direction is greater than or equal to the predetermined deviation
